(19) United States
(12) Patent Application Publication
(10) Pub. No.: US 2014/0283152 A1
(43) Pub. Date: Sep. 18, 2014

(54) METHOD FOR ARTIFICIAL SELECTION

(71) Applicant: University of Florida Research Foundation, Inc., Gainesville, FL (US)

(72) Inventors: Matias Kirst, Gainesville, FL (US); Marcio F. Resende, JR., Gainesville, FL (US); Patricio Muñoz, Gainesville, FL (US); Gary F. Peter, Gainesville, FL (US)

(73) Assignee: University of Florida Research Foundation, Inc., Gainesville, FL (US)

(21) Appl. No.: 14/203,430

(22) Filed: Mar. 10, 2014

Related U.S. Application Data
(60) Provisional application No. 61/784,366, filed on Mar. 14, 2013.

(51) Int. Cl. G06F 19/18

(52) U.S. Cl. CPC G06F 19/18
USPC 800/8; 435/6.11; 506/2; 506/9; 800/260; 800/275; 702/19

(57) ABSTRACT

The present invention provides methods of determining the breeding value of an individual or determining the best pair of individuals to mate based on additive and non-additive factors. The invention further provides methods of breeding an individual selected by using a molecular marker-derived matrix comprising additive and non-additive effects. The invention also provides a kit for determining the Estimated Breeding Value of an individual.

### CROSS REFERENCE TO RELATED APPLICATIONS

This application claims the benefit of U.S. Provisional Application No. 61/784,366, filed Mar. 14, 2013, herein incorporated by reference in its entirety.

### STATEMENT REGARDING FEDERALLY SPONSORED RESEARCH

This invention was made with government support under grant number 2010-85117-20569 awarded by the USDA. The government has certain rights in the invention.

### FIELD OF THE INVENTION

The invention relates to the field of breeding. More specifically, the invention relates to methods of identifying plants and animals having a beneficial breeding value.

### BACKGROUND OF THE INVENTION

Traditional breeding programs typically use breeding values to select desired individuals. Quantitative models of selection of individuals for breeding are based in the expectations of genetic variances, the amount/quality of data, and the expected relationships among the individuals. For a desired trait, methods are needed to better estimate breeding value by taking into account all aspects of genetic variance, thus resulting in more effective selection of individuals and crosses by breeders. The identification of single nucleotide polymorphisms (SNPs) has facilitated the use of genome-wide genetic markers to assist in assigning breeding values and selection of desired individuals for breeding.

### SUMMARY OF THE INVENTION

In one aspect, the invention provides a method of obtaining an individual with a desired estimated breeding value, the method comprising: (a) determining a genotype of a plurality of individuals for a plurality of genetic markers; (b) constructing a molecular marker-derived matrix comprising additive and non-additive effects; (c) obtaining an estimated breeding value (EBV) for the individuals based on the matrix comprising additive and non-additive effects; and (d) selecting at least a first individual with a desired EBV for breeding. In one embodiment, the non-additive effects comprise dominance effects or epistatic effects. For instance, the epistatic effects may comprise additive-by-additive (Add×Add) interactions, dominance-by-dominance (Dom×Dom) interactions, or additive-by-dominance (Add×Dom) interactions. In another embodiment, the dominance relationship matrix for use in the method is constructed using the formula:

$$D = \frac{{WW}^{′}}{{\sum }_{j = 1}^{m} 2 {p}_{j} {q}_{j} ( 1 - 2 {p}_{j} {q}_{j} )} ,$$

wherein Wij=1−2pⱼqⱼ if the individual is heterozygous, and Wij=0 if the individual has missing data, and Wij=0−2pⱼqⱼ if the individual is homozygous. In yet another embodiment, the selecting step of the method occurs before an individual fully exhibits a trait.

In still another embodiment, the genetic markers of the invention are polymorphic. For instance, in certain embodiments, the genetic markers are selected from the group consisting of unique expressed sequence tags (EST); restriction fragment length polymorphisms (RFLP), amplified fragment length polymorphisms (AFLP), simple sequence repeats (SSR), simple sequence length polymorphisms (SSLPs), single nucleotide polymorphisms (SNP), insertion/deletion polymorphisms (Indels), variable number tandem repeats (VNTR), random amplified polymorphic DNA (RAPD), and isozymes. In certain embodiments, the minor genotype frequency of the genetic markers is greater than 0.12. In other embodiments, each genetic marker has a predetermined association with at least one desired trait or phenotype. In one embodiment, the desired phenotype is monogenic, quantitative, or polygenic.

In a further embodiment, the method further comprises: (e) breeding the individual to a second individual to obtain progeny. In one embodiment, the second individual is selected based on an obtained estimated breeding value. In another embodiment, the method further comprises (f) determining a genotype of a plurality of the progeny for a plurality of genetic markers; (g) constructing a molecular marker-derived matrix comprising additive and non-additive effects; (h) obtaining an estimated breeding value (EBV) for the progeny based on the matrix comprising additive and non-additive effects; and (i) selecting at least a first progeny from the plurality with a desired EBV for breeding.

In yet another embodiment, the individual is a plant, for instance, including but not limited to a corn, canola, flax, alfalfa, rice, rye, sorghum, sunflower, wheat, soybean, tobacco, potato, peanut, cotton, sweet potato, cassava, coffee, coconut, pineapple, citrus, banana, fig, sugar beet, oat, barley, vegetable, turfgrass, tree, or ornamental plant. In still another embodiment, the individual is an animal, for instance including, but not limited to, a horse, beef cattle, dairy cattle, swine, poultry, sheep, goat, or fish.

In another aspect, the invention provides a method of obtaining a progeny individual with a desired genetic value, the method comprising: (a) determining a genotype of a plurality of individuals for a plurality of genetic markers; (b) constructing a molecular marker-derived predicted progeny performance matrix comprising additive and non-additive effects; (c) obtaining a predicted mean family genetic value for a plurality of potential progeny of any two of the plurality of individuals, wherein the predicted mean family genetic value is based on the predicted progeny performance matrix comprising additive and non-additive effects; (d) selecting at least a first potential progeny with a desired predicted mean family genetic value; (e) determining the pair individuals from the plurality of individuals corresponding to the parents of the selected potential progeny; and (f) breeding the pair of individuals to produce a progeny individual with a desired genetic value. In one embodiment, the non-additive effects comprise dominance effects or epistatic effects. In another embodiment, the epistatic effects comprise additive-by-additive (Add×Add) interactions, dominance-by-dominance (Dom×Dom) interactions, or additive-by-dominance (Add×Dom) interactions. In yet another embodiment, the predicted progeny performance matrix is constructed using the formula:

Gᵢⱼ=Σₖ₌₁^{N}[P(AA)ᵢⱼₖaₖ+P(Aa)ᵢⱼₖdₖ−P(aa)ᵢⱼₖaₖ].

In other embodiments, the genetic markers are polymorphic and may be selected from the group consisting of unique expressed sequence tags (EST); restriction fragment length polymorphisms (RFLP), amplified fragment length polymorphisms (AFLP), simple sequence repeats (SSR), simple sequence length polymorphisms (SSLPs), single nucleotide polymorphisms (SNP), insertion/deletion polymorphisms (Indels), variable number tandem repeats (VNTR), and random amplified polymorphic DNA (RAPD), and isozymes. In other embodiments, the minor genotype frequency of the genetic markers is greater than 0.12, each genetic marker has a predetermined association with at least one desired trait or phenotype, or the desired phenotype is monogenic, quantitative, or polygenic. In other embodiments, the progeny individual is a plant and may be a corn, canola, flax, alfalfa, rice, rye, sorghum, sunflower, wheat, soybean, tobacco, potato, peanut, cotton, sweet potato, cassava, coffee, coconut, pineapple, citrus, banana, fig, sugar beet, oat, barley, vegetable, turfgrass, a tree, or an ornamental plant. In still further embodiments, the progeny individual is an animal and may be a horse, beef cattle, dairy cattle, swine, poultry, sheep, goat, or fish.

### BRIEF DESCRIPTION OF THE DRAWINGS

For a more complete understanding of the features and advantages of the present invention, reference is now made to the detailed description of the invention along with the accompanying figures and in which:

FIG. 1: Shows Eigenvalue distribution for a perfect orthogonal correlation matrix (a), for models including additive and dominance (b), and for models including additive, dominance, and epistasis (c). White box for pedigree-derived models, and grey for marker-derived models.

FIG. 2: Shows standard error of the prediction (SEP) for pedigree-derived matrices model against their counterpart using markers-derived matrices; (a) SEP for BV prediction model including Add×Dom interaction; (b) SEP for dominance value (DV) prediction model including Add×Dom interaction; (c) SEP for BV prediction model including Dom×Dom interaction; (d) SEP for DV prediction model including Dom×Dom interaction.

FIG. 3: Shows predicted mean family values for height, based on models that include additive and dominance effects. Each potential parent (1 to 926) from CCLONES is represented in the X and Y-axis. Each position in the heat map represents the in silico prediction of the outcome of a cross. Units are the deviation from the overall predicted population mean, in centimeters.

FIG. 4: Illustrative computing system that may be utilized for generating and maintaining molecular marker-derived matrices.

FIG. 5: Flow diagram of an illustrative process for breeding an individual or a pair of individuals in accordance with the principles of the present invention.

### DETAILED DESCRIPTION OF THE INVENTION

The methods of the present invention provide for improved genetic identification of individuals with specific qualities in the same or future generations and the identification of parents that create progeny with specific qualities in future generations. These methods therefore provide means for more accurate estimation of superior or elite individuals for early selection and allow for mate pair allocation, making it possible to predict the outcome of a cross to select the best parents or the best cross. The invention thus permits substantial improvement in breeding populations, for example, in plants or animals.

Non-additive effects have to date been highly overlooked in animal and plant breeding, mainly because traditional methods for variance estimation yield usually small estimates compared to additive effects. For instance, non-additive effects have been neglected because their estimation requires the use of complex experimental designs (i.e., crosses). The present inventors have found, however, that consideration of both additive and non-additive genetic effects may be combined to provide enhanced breeding value estimates for an individual, thereby improving the ability to selectively breed for any given trait(s).

An “estimated breeding value” or “EBV” as referred to herein is a statistical numerical prediction of the relative genetic value of a particular individual for breeding. In one embodiment of the invention, an individual may be selected for breeding based upon its EBV. In particular, an individual with a desirable EBV may be selected. In certain embodiments, a desirable EBV may refer to an EBV that is greater than the average EBV of the population of individuals being selected from. For instance, a desired EBV may be within the top 50%, 40%, 30%, 25%, 20%, 15%, 10%, 5%, 4%, 3%, 2%, 1% of the population the individual is selected from.

A “predicted mean family genetic value” or “predicted mean family value” as used herein refers to a statistical numerical prediction of the mean genetic value of the potential offspring produced by a given set of parents. In one embodiment, the mean family genetic value may be predicted for a plurality of matings between individuals in a population. In another embodiment, a pair of individuals may be selected to be bred together based on the predicted mean family genetic value generated for that cross.

The use of molecular markers, largely focused on additive effects that contribute to traits, has become a widely used tool for predicting breeding values and many methodologies have been proposed, which estimate the additive relationships among individuals in a population. Such estimation, called realized relationship matrix (Ga) also referred to in the art as Observed or Genomic Relationship Matrix, provides some advantages over relationship matrices derived from pedigree. This is because, for instance, the Ga matrix more accurately describes the true additive relationship among individuals known to be related by providing an estimation of the Mendelian sampling and also providing an estimation of the relationship for individuals not known to be related. The present invention provides a method to derive non-additive relationship matrices to partition the genetic variance components. A non-additive relationship matrix can be used for several purposes, such as a more accurate estimation of (1) genetic parameters, such as heritability, (2) the predicted breeding value of an individual, (3) the predicted genetic value of progeny derived from a given cross and (4) the predicted optimum cross between two selected individuals to produce a desired progeny.

In certain embodiments, relationship matrices of the present invention that include both additive effects and non-additive effects, for use as genome-wide selection predictive models, allow breeders to select superior or elite individuals for breeding and to identify mate-pairs that generate families with optimal allelic combinations. In one embodiment, use of such genome-wide selection predictive models may reduce the cost and complexity of breeding programs, by allowing breeders to precisely define the specific crosses that will create the best possible allelic combination (i.e., allocate mate-pairs) thereby reducing the magnitude of the breeding effort.

A matrix of the present disclosure may be constructed by any formula for additive or non-additive relationship matrices known in the art. In accordance with the present invention, a relationship matrix can be created to describe contributions of additive effects (Ga), dominance (non-additive) effects (Gd), and epistatic (non-additive) effects on variance. Genetic variance in a population encompasses number of factors, including additive effects, dominance effects and epistatic effects. The term “dominance” as used herein refers to an interaction between different alleles of a gene at a heterozygous locus, wherein one allele has more effect than the other allele. The term “epistasis” refers to an interaction between genes at different loci, for instance, wherein one locus on a chromosome masks the expression of another locus on a separate chromosome. In accordance with the present invention, the term “additive” refers to transmission of a trait in a linear fashion, from a parent to an offspring. Additive genetic variance is a component of genetic variation wherein alleles contribute a fixed value to a measure of genetic variance of a quantitative trait. In traditional breeding methods, an EBV based on additive effects alone are typically calculated for individuals to be used for breeding, such as a plant or animal. Consequently, many breeding programs rely only on these breeding values to make progress, completely ignoring non-additive effects, such as dominance or epistasis.

Partitioning the genetic variance into additive, dominance, and epistasis components is not always possible because the estimations are highly correlated (Hill, Philosoph Transact Royal Society B-Biol Sci, 365:73-85, 2010) and confounded with each other (Lynch et al., Genetics and Analysis of Quantitative Traits, 1998). Additionally, depending on the gene frequencies involved, non-additive allelic effects can greatly inflate the additive variance estimates (Lu et al. Can J Forest Res, 29:724-736, 1999; Zuk et al., PNAS USA, 109:1193-1198, 2012) and therefore impact the breeding value predictions (Palucci et al., Genet Select Evol, 39:181-193, 2007; Vanderwerf et al., J Dairy Sci, 72:2606-2614, 1989).

However, the proper partition of variance components can generate basic understanding of the genetic architecture of a trait, define the breeding strategy and maximize the genetic gains. Thus, ignoring existing non-additive effects may negatively impact a traditional breeding program that selects using additive effects in two ways. First, the heritability and breeding values, and thus the projected genetic gain, will be inflated. Second, the variability due to non-additive effects cannot be exploited in the next generation, as the program selects by breeding values, and if family or clonal propagation is possible in the breeding program, then the potential to exploit this variability and reach the maximum genetic gain possible will be lost.

In order to partition the genetic variation into additive and dominance components, special mating design in breeding populations is needed, with relationships at least at the level of full-sib. Furthermore, the partition at the epistatic level requires either inbreeding or vegetative propagated (clonal) populations. In perennial plants with long rotations (>5 years), inbreeding is not used because of the generation length, and the amount of inbreeding depression is often a common problem, leaving clonal populations as the only option to explore the full genetic architecture (Foster et al., Theor Appl Genet, 76:788-794, 1988).

Several studies of clonal populations have been generated with the objective of partitioning the genetic variance using traditional quantitative pedigree-based genetics (Foster et al., Theor Appl Genet, 76:788-794, 1988; Mullin et al., Can J Forest Res, 22:24-361992; Wu, Theor Appl Genet, 93:102-109, 1996; Isik et al., Forest Science, 49:77-88, 2003; Isik, et al., Can J Forest Res, 35:1754-1766, 2005; Costa e Silva et al., Theor Appl Genet, 108:1113-1119, 2004, Costa e Silva et al., Tree Genet Genomes, 5:291-305, 2009; Baltunis et al., Tree Genet Genomes, 3:227-238, 2007; Baltunis et al., Tree Genet Genomes, 4:797-807, 2008; Baltunis et al., Tree Genet Genomes, 5:269-278, 2009; Araujo et al. Tree Genet Genomes, 8:327-337, 2012), with the common result of small estimated values for dominance variation and often null or negative values for epistasis variation.

Any statistical model for predicting BVs based on molecular markers known in the art may be used in the present invention. In one embodiment of the invention, Ga is used instead of the numerator relationship matrix (A) in Best Linear Unbiased Prediction (BLUP) analysis (GBLUP) to predict BVs. BLUP, and thus GBLUP, is a well-known easily-understood methodology by breeders, and is equivalent to ridge regression BLUP (RR-BLUP) (VanRaden, Science, 91:4414-4423, 2008). In addition, as GBLUP uses the same properties as BLUP, an extended animal model can be fitted, incorporating dominance effects, and replacing the pedigree-derived non-additive relationship matrix (Mrode, Linear models for the prediction of animal breeding values. CABI Publishing Series, 2005) with the marker-derived counterpart. As described above, the Ga is advantageous over the relationship matrix derived from a pedigree. The Ga matrix may be, in certain embodiments, combined with the A matrix (Aguilar et al., J Dairy Sci, 93:743-752, 2010) to obtain more accurate estimates of variance components (Chen et al., J Anim Sci, 89:23-28, 2011; Veerkamp et al., J Dairy Sci, 94:4189-4197, 2011). Additionally, it has been shown that, by using the Ga instead of A, better separation of genetics and environmental effects is possible (Lee et al., Genet Select Evol, 42, 2010). Likewise, the marker-derived relationship matrices allow a better separation of genetic variation, revealing the genetic architecture of complex quantitative traits.

Methods of the present invention may evaluate traits including, but not limited to, complex/quantitative traits, monogenic traits, and/or polygenic traits. Such traits in plants may include, for example, reproductive health, plant height, yield, biomass, increased or decreased tolerance to stresses, both biotic or abiotic, or to a chemical such as a pesticide or a herbicide, and the like. Such traits in animals may include, for example, weight, weaning weight, carcass composition such as marbling and back fat, hip structure, litter size, fertility, reproductive health, and the like. An “individual” or “subject” in accordance with the present invention may be a plant including, but not limited to an agricultural plant or tree. Agricultural plants or trees as used herein generally refer to plants and trees grown primarily for food or production purposes. Such plants and trees include but are not limited to rice, soybean, corn, canola, sorghum, sugarcane, cotton, coffee, tomato, pine, oak, maple, citrus, or the like. In addition, an “individual” or “subject” may be an animal including, but not limited to a livestock animal. Livestock animals as used herein generally refer to animals raised primarily for food. Such animals include, but are not limited to cattle, swine, horse, goat, sheep, dog, ostrich, chicken, turkey, and the like. As used herein, the term “plant” includes plant cells, plant protoplasts, plant cells of tissue culture from which plants can be regenerated, plant calli, plant clumps and plant cells that are intact in plants or parts of plants such as pollen, flowers, seeds, leaves, stems, and the like.

As used herein, a “marker” means a detectable characteristic that can be used to discriminate between biological sample from different organisms. Samples may comprise, for example, blood, serum, plasma, saliva, or cells. Examples of detectable characteristics include, but are not limited to, genetic markers, biochemical markers, metabolites, morphological characteristics, and agronomic characteristics. Molecular markers of the present invention may include “dominant” or “codominant” markers. “Codominant” markers reveal the presence of two or more alleles (two per diploid individual). “Dominant” markers reveal the presence of only a single allele. Markers are preferably inherited in codominant fashion so that the presence of both alleles at a diploid locus, or multiple alleles in triploid or tetraploid loci, are readily detectable, and they are free of environmental variation, i.e., their heritability is 1.

A marker genotype typically comprises two marker alleles at each locus in a diploid organism. The marker allelic composition of each locus can be either homozygous or heterozygous. Homozygosity is a condition where both alleles at a locus are characterized by the same nucleotide sequence. Heterozygosity refers to different conditions of the allele at a locus. As used herein, an “allele” refers to one of two or more alternative forms of a genomic sequence at a given locus on a chromosome. As used herein, the term “phenotype” means the detectable characteristics of a cell or organism that can be influenced by gene expression and the term “genotype” means the specific allelic makeup of a plant. As used herein, the term “linked,” when used in the context of nucleic acid markers and/or genomic regions, means that the markers and/or genomic regions are located on the same linkage group or chromosome such that they tend to segregate together at meiosis.

Genetic markers that can be used in the practice of the present invention include, but are not limited to, unique expressed sequence tags (EST); restriction fragment length polymorphisms (RFLP), amplified fragment length polymorphisms (AFLP), simple sequence repeats (SSR), simple sequence length polymorphisms (SSLPs), single nucleotide polymorphisms (SNP), insertion/deletion polymorphisms (Indels), variable number tandem repeats (VNTR), and random amplified polymorphic DNA (RAPD), isozymes, and others known to those skilled in the art. Marker discovery and development in crops provides the initial framework for applications to marker-assisted breeding activities (U.S. Patent Pub. Nos.: 2005/0204780, 2005/0216545, 2005/0218305, and 2006/00504538). The resulting “genetic map” is the representation of the relative position of characterized loci (polymorphic nucleic acid markers or any other locus for which alleles can be identified) to each other. Embodiments of the invention may include one or a plurality of markers. As described herein, a plurality of markers may include at least about 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10 000, 20 000, 30 000, 40 000, 50 000, 60 000, 70 000, 80 000, 90 000, 100 000, or more.

Polymorphisms comprising as little as a single nucleotide change can be assayed in a number of ways. For example, detection can be made by electrophoretic techniques including a single strand conformational polymorphism (Orita et al. (1989) Genomics 8(2), 271-278), denaturing gradient gel electrophoresis (Myers (1985) EPO 0273085), or cleavage fragment length polymorphisms (Life Technologies, Inc., Gathersberg, Md. 20877), but the widespread availability of DNA sequencing machines often makes it easier to just sequence amplified products directly. Once the polymorphic sequence difference is known, rapid assays can be designed for progeny testing, typically involving some version of PCR amplification of specific alleles (PASA, Sommer, et al. (1992) Biotechniques 12(1), 82-87), or PCR amplification of multiple specific alleles (PAMSA, Dutton and Sommer (1991) Biotechniques 11(6), 700-7002).

As a set, polymorphic markers serve as a useful tool for fingerprinting plants to inform the degree of identity of lines or varieties (U.S. Pat. No. 6,207,367). These markers form the basis for determining associations with phenotypes and can be used to drive genetic gain. A breeder may select for a desired phenotype or track such desired phenotype during breeding using molecular markers. One of ordinary skill can introduce a desired phenotype into any genetic background. For many breeding objectives, commercial breeders may work within a genetic background that is often referred to as the “cultivated type” or “elite.” For horticultural purposes, this germplasm is easier to breed with because it generally performs well. The performance advantage a cultivated type provides is sometimes offset by a lack of allelic diversity. This is the tradeoff a breeder accepts when working with cultivated germplasm-better overall performance, but a lack of allelic diversity. Breeders generally accept this tradeoff because progress is faster when working with cultivated material than when breeding with genetically diverse sources. Similar advantages and disadvantages are associated with the use of elite individuals in animal breeding practices as well.

In contrast, for plant breeders, when making either intra-specific crosses, or inter-specific crosses, a converse trade off occurs. In these examples, a breeder typically crosses cultivated germplasm with a non-cultivated type. In such crosses, the breeder can gain access to novel alleles from the non-cultivated type, but may have to overcome the genetic drag associated with the donor parent. Because of the difficulty with this breeding strategy, this approach often fails because of fertility and fecundity problems. The difficulty with this breeding approach extends to many plant species, and is exemplified with an important disease resistant phenotype that was first described in tomato in 1944 (Smith, Proc Am Soc Hort Sci 44:413-16). In this cross, a nematode disease resistance was transferred from L. peruvianum (PI128657) into a cultivated tomato. Despite intensive breeding, it was not until the mid-1970's before breeders could overcome the genetic drag and release successful lines carrying this trait. Indeed, even today, tomato breeders deliver this disease resistance gene to a hybrid variety from only one parent.

Some phenotypes are determined by the genotype at one locus. These simple traits, like those studied by Gregor Mendel, fall in discontinuous categories such as green or yellow seeds. Most variation observed in nature, however, is continuous, like yield in field corn, or human blood pressure. Unlike simply inherited traits, continuous variation can be the result of polygenic inheritance. Loci that affect continuous variation are referred to as QTLs. Variation in the phenotype of a quantitative trait is the result of the allelic composition at the QTLs and the environmental effect. In accordance with the present invention, “heritability” refers to a statistical measurement of how well a quantitative trait is passed from parent to offspring. The heritability of a trait is therefore the proportion of the phenotypic variation attributed to the genetic variance. This ratio varies between 0 and 1.0. Thus, a trait with heritability near 1.0 is not greatly affected by the environment. Those skilled in the art recognize the importance of creating commercial lines or elite individuals with high heritability traits.

Certain embodiments of the invention provide early selection of an individual for breeding. Early selection may include selection of an individual for breeding before the individual fully exhibits a trait or phenotype, or before a trait is fully established in an individual.

Embodiments of the invention may provide a kit for determining the EBV of an individual. Such a kit may include means for detecting a plurality of genetic markers that may be used to construct a molecular marker-derived matrix comprising additive and non-additive effects. Once such a matrix is constructed, an EBV may be calculated for an individual. In vitro test kits (e.g., reagent kits) for determining the EBV of an individual may include reagents, materials, and protocols for assessing one or more biomarkers (e.g., nucleic acids, proteins, or the like), instructions and, optionally, software for comparing the biomarker data between individuals. Useful reagents and materials for kits include, but are not limited to PCR primers, hybridization probes and primers (e.g., labeled probes or primers), allele-specific oligonucleotides, reagents for genotyping SNP markers, reagents for detection of labeled molecules, restriction enzymes (e.g., for RFLP analysis), DNA polymerases, RNA polymerases, DNA ligases, marker enzymes, microarrays, antibodies, means for amplification of nucleic acid fragments from one or more individuals, means for analyzing the nucleic acid sequence of one or more individuals or fragments thereof, or means for analyzing the sequence of one or more amino acid residues from one or more individuals to be selected for breeding.

Nucleic acid-based analyses for determining the presence or absence of a genetic polymorphism (i.e., for genotyping) can be used in breeding programs for identification, selection, introgression, and the like. A wide variety of genetic markers for the analysis of genetic polymorphisms are available and known to those of skill in the art.

As used herein, nucleic acid analysis methods include, but are not limited to, PCR-based detection methods (i.e., TaqMan assays), microarray methods, mass spectrometry-based methods and/or nucleic acid sequencing methods, including whole genome sequencing. In certain embodiments, the detection of polymorphic sites in a sample of DNA, RNA, or cDNA may be facilitated through the use of nucleic acid amplification methods. Such methods specifically increase the concentration of polynucleotides that span the polymorphic site, or include that site and sequences located either distal or proximal to it. Such amplified molecules can be readily detected by gel electrophoresis, fluorescence detection methods, or other means.

One method of achieving such amplification employs the polymerase chain reaction (PCR) (Mullis et al., 1986 Cold Spring Harbor Symp Quant Biol 51:263-273; European Patent 50,424; European Patent 84,796; European Patent 258,017; European Patent 237,362; European Patent 201,184; U.S. Pat. No. 4,683,202; U.S. Pat. No. 4,582,788; and U.S. Pat. No. 4,683,194), using primer pairs that are capable of hybridizing to the proximal sequences that define a polymorphism in its double-stranded form. Methods for typing DNA based on mass spectrometry can also be used. Such methods are disclosed in U.S. Pat. Nos. 6,613,509 and 6,503,710, and references found therein.

Polymorphisms in DNA sequences can be detected or typed by a variety of effective methods well known in the art including, but not limited to, those disclosed in U.S. Pat. Nos. 5,468,613, 5,217,863; 5,210,015; 5,876,930; 6,030,787; 6,004,744; 6,013,431; 5,595,890; 5,762,876; 5,945,283; 5,468,613; 6,090,558; 5,800,944; 5,616,464; 7,312,039; 7,238,476; 7,297,485; 7,282,355; 7,270,981 and 7,250,252 all of which are incorporated herein by reference in their entireties. However, the compositions and methods of the present invention can be used in conjunction with any polymorphism typing method to type polymorphisms in genomic DNA samples. These genomic DNA samples used include but are not limited to genomic DNA isolated directly from a plant or animal, cloned genomic DNA, or amplified genomic DNA.

For instance, polymorphisms in DNA sequences can be detected by hybridization to allele-specific oligonucleotide (ASO) probes as disclosed in U.S. Pat. Nos. 5,468,613 and 5,217,863. U.S. Pat. No. 5,468,613 discloses allele specific oligonucleotide hybridizations where single or multiple nucleotide variations in nucleic acid sequence can be detected in nucleic acids by a process in which the sequence containing the nucleotide variation is amplified, spotted on a membrane and treated with a labeled sequence-specific oligonucleotide probe.

Target nucleic acid sequence can also be detected by probe ligation methods as disclosed in U.S. Pat. No. 5,800,944, in which a sequence of interest is amplified and hybridized to probes, followed by ligation to detect a labeled part of the probe.

Microarrays can also be used for polymorphism detection, wherein oligonucleotide probe sets are assembled in an overlapping fashion to represent a single sequence such that a difference in the target sequence at one point would result in partial probe hybridization (Borevitz et al., Genome Res. 13:513-523 (2003); Cui et al., Bioinformatics 21:3852-3858 (2005). On any one microarray, it is expected there will be a plurality of target sequences, which may represent genes and/or noncoding regions wherein each target sequence is represented by a series of overlapping oligonucleotides, rather than by a single probe. This platform provides for high throughput screening of a plurality of polymorphisms. Typing of target sequences by microarray-based methods is disclosed in U.S. Pat. Nos. 6,799,122; 6,913,879; and 6,996,476.

Target nucleic acid sequence can also be detected by probe linking methods as disclosed in U.S. Pat. No. 5,616,464, employing at least one pair of probes having sequences homologous to adjacent portions of the target nucleic acid sequence and having side chains which non-covalently bind to form a stem upon base pairing of the probes to the target nucleic acid sequence. At least one of the side chains has a photoactivatable group which can form a covalent cross-link with the other side chain member of the stem.

Other methods for detecting SNPs and Indels include single base extension (SBE) methods. Examples of SBE methods include, but are not limited, to those disclosed in U.S. Pat. Nos. 6,004,744; 6,013,431; 5,595,890; 5,762,876; and 5,945,283. SBE methods are based on extension of a nucleotide primer that is adjacent to a polymorphism to incorporate a detectable nucleotide residue upon extension of the primer. In certain embodiments, the SBE method uses three synthetic oligonucleotides. Two of the oligonucleotides serve as PCR primers and are complementary to sequence of the locus of genomic DNA which flanks a region containing the polymorphism to be assayed. Following amplification of the region of the genome containing the polymorphism, the PCR product is mixed with the third oligonucleotide (called an extension primer) which is designed to hybridize to the amplified DNA adjacent to the polymorphism in the presence of DNA polymerase and two differentially labeled dideoxynucleosidetriphosphates. If the polymorphism is present on the template, one of the labeled dideoxynucleosidetriphosphates can be added to the primer in a single base chain extension. The allele present is then inferred by determining which of the two differential labels was added to the extension primer. Homozygous samples will result in only one of the two labeled bases being incorporated and thus only one of the two labels will be detected. Heterozygous samples have both alleles present, and will thus direct incorporation of both labels (into different molecules of the extension primer) and thus both labels will be detected.

In another method for detecting polymorphisms, SNPs and Indels can be detected by methods disclosed in U.S. Pat. Nos. 5,210,015; 5,876,930; and 6,030,787 in which an oligonucleotide probe having a 5′ fluorescent reporter dye and a 3′ quencher dye covalently linked to the 5′ and 3′ ends of the probe. When the probe is intact, the proximity of the reporter dye to the quencher dye results in the suppression of the reporter dye fluorescence, e.g. by Forster-type energy transfer. During PCR forward and reverse primers hybridize to a specific sequence of the target DNA flanking a polymorphism while the hybridization probe hybridizes to polymorphism-containing sequence within the amplified PCR product. In the subsequent PCR cycle DNA polymerase with 5′→3′ exonuclease activity cleaves the probe and separates the reporter dye from the quencher dye resulting in increased fluorescence of the reporter.

In another embodiment, the locus or loci of interest can be directly sequenced using nucleic acid sequencing technologies. Methods for nucleic acid sequencing are known in the art and include technologies provided by 454 Life Sciences (Branford, Conn.), Agencourt Bioscience (Beverly, Mass.), Applied Biosystems (Foster City, Calif.), LI-COR Biosciences (Lincoln, Nebr.), NimbleGen Systems (Madison, Wis.), Illumina (San Diego, Calif.), and VisiGen Biotechnologies (Houston, Tex.). Such nucleic acid sequencing technologies comprise formats such as parallel bead arrays, sequencing by ligation, capillary electrophoresis, electronic microchips, “biochips,” microarrays, parallel microchips, and single-molecule arrays, as reviewed by R. F. Service Science 2006 311:1544-1546.

The term “about” as used herein indicates that a value includes the standard deviation of error for the device or method being employed to determine the value. The use of the term “or” in the claims is used to mean “and/or” unless explicitly indicated to refer to alternatives only or the alternatives are mutually exclusive, although the disclosure supports a definition that refers to only alternatives and to “and/or.” When used in conjunction with the word “comprising” or other open language in the claims, the words “a” and “an” denote “one or more,” unless specifically noted. The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps. Similarly, any plant that “comprises,” “has” or “includes” one or more traits is not limited to possessing only those one or more traits and covers other unlisted traits.

Unless otherwise defined, all technical terms used herein have the same meaning as commonly understood by one of ordinary skill in the art to which this invention belongs. Other objects and features will be in part apparent and in part pointed out hereinafter.

### EXAMPLES

The following examples describe the use of molecular marker-derived additive and non-additive relationship matrices to partition the genetic variance component they are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Experimental Design and Data Collection

For complex traits such as total tree height, different BLUP models were compared under additive and full (additive plus non-additive) assumptions with the use of either the pedigree-derived relationship matrix or the marker-derived matrices in a clonal population of Pinus taeda.

The complex trait total tree height (HT, m) measured at year 6 from a single field trial on the CCLONE population (Resende et al., New Phytologist, 193:617-624, 2012; Resende et al., Genetics, 190:1503-10, 2012) was used in the present study. In summary, 32 parents were crossed in a circular mating design with additional off-diagonal crosses, resulting in 70 full-sib families with an average of 13.5 individuals per family. The clonal field trial was established using single-tree plots in eight replicates (one ramet per replicate) in a resolvable alpha-incomplete block design (Williams et al. 2002). Four of the replicates were grown under high intensity silviculture, while the rest were under a standard silviculture regime.

A subset of the CCLONES population, composed of 951 individuals from 61 families was genotyped using an Illumina Infinium™ assay (Illumina, San Diego, Calif. (Eckert et al., Genetics, 185:969-982, 2010) with 7,216 SNPs, each representing a unique pine EST contig. A subset of 4,853 SNPs were polymorphic in this population.

### Example 2

### Construction of Relationship Matrices

Out of the polymorphic markers, a total of 2,182 SNPs had a minor genotype frequency greater than 0.12. This last subset was used to estimate Ga following the method from Powell et al. (Nat Rev Genet, 11:800-805, 2010), where identity by descent coefficients are determined relative to the parents of the current population as base population. The relationship values from Ga were adjusted as recommended by Yang et al. (Nat Genet, 42:565-U131, 2010) to lessen estimation error. The resulting Ga was used to correct the pedigree as detailed in Munoz et al. (Submitted to Genetic Selection Evolution, 2012). In addition, a molecular marker derived dominance relationship matrix (Gd) was constructed. To build a dominance relationship matrix, a matrix W was created where a new codification was established for the genotypic file containing all the polymorphic SNPs. Thus, W has the dimension n individuals×m markers and was re-parameterized to be coded 1 if the genotype was heterozygous and 0 if the genotype was homozygous for either class (AA or aa). The matrix W was further standardized to have mean 0. In order to do that, the expectation of Wj for the j-th marker was derived to be 2pⱼqⱼ. Thus, Wij for the i-th individual and j-th marker received the code:

Wij=1−2pⱼc_{b} if the individual is heterozygous

Wij=0 if the individual has a missing data

Wij=0−2pⱼqⱼ otherwise.

Starting from matrix W, the dominance relationship matrix was constructed by:

$$D = \frac{{WW}^{′}}{{\sum }_{j = 1}^{m} 2 {p}_{j} {q}_{j} ( 1 - 2 {p}_{j} {q}_{j} )}$$

In addition, relationship matrices were obtained from the pedigree for additive relationships (A) and dominance relationships (D) following traditional methods (Lynch and Walsh, Genetics and Analysis of Quantitative Traits. Sinauer, Sunderland, Mass., 1998; and Mrode, Linear models for the prediction of animal breeding values. CABI Publishing Series, 2005). The Hadamard product between matrices was used to obtain the epistasis relationship matrices additive-by-additive (Add×Add), dominance-by-dominance (Dom×Dom) and additive-by-dominance (Add×Dom) interaction for pedigree-derived AA, DD, and AD, and markers-derived Gaa, Gdd, and Gad, respectively.

### Example 3

### Genetic Analyses

All analyses were carried out in the software ASReml v3.0 (Gilmour et al. 2009), a genetic-statistics software for fitting mixed model on complex datasets using the sparse matrix methods and equipped with the Residual Maximum Likelihood (REML) using the average information algorithm (Gilmour et al., ASReml User Guide Release 3.0.VSN International Ltd, Hemel Hempstead, UK, 1995). Six linear mixed models were fitted using the pedigree-derived matrices, while eleven models were fitted using the marker-derived matrices as detailed below.

Six models were fitted using the pedigree-derived matrices (models 1 to 6) and six models using the markers-derived matrices (models 7 to 11), from the simpler (additive) to the more complex (additive plus dominance plus two-way epistasis interaction), for simplicity the model including all terms (model 6 or 11) is show below

y=+Xβ+Z₁i+Z₂a+Z₃t₁+Z₄d+Z₅t₂+Z₆iₐₐ+Z₇i_{dd}+Z₈i_{ad}+e

where y is the phenotypic HT measure, β is a vector of the fixed effects (i.e. silvicultural treatment and replicate), i is a vector of the random incomplete block effects within replication ˜N(0, Iσ²ᵢ), a is a vector of random additive effects of genotypes ˜N(0, V₁σ²ₐ), t₁ is a vector of the random additive by silviculture type interaction ˜N(0, V₁ [symbol] Iσ²ₜ₁), d is a vector of random dominance effect of genotypes ˜N(0, V₂σ²_{d}), t₂ is a vector of the random dominance by silviculture type interaction ˜N(0, V₁ [symbol] Iσ²ₜ₂), iₐₐ is a vector of the random Add×Add interaction ˜N(0, V₁#V₁σ²ᵢₐₐ), i_{dd} is a vector of the random Dom×Dom interaction ˜N(0, V₂#V₂σ²_{idd}), iₐₛ is a vector of the random Add×Dom interaction ˜N(0, V₁#V₂σ²_{iad}), and e is the vector of random residual effects ˜N(0, Iσ²ₑ). The incidence matrices are X, Z₁-Z₈, while I is the identity matrix, [symbol] represents the Kronecker product and # the Hadamard product. The matrix V₁ and V₂ corresponded to an additive and dominance relationship matrices either derived from the pedigree replaced for A and D or from the markers replaced for Ga and Gd, respectively.

Models 1 (A_ped) and 7 (Ga_MM) were fitted with only the additive effect and its interaction with silviculture. Thus, the estimated additive variance (V⁻_{↓}A) equals the genetic variance component (V⁻_{↓}G) as in this model non-additive effects are assumed to be zero \hat{V}_{G}=\hat{V}_{A}=\hat{σ}ₐ² and the total variance is \hat{V}ₚ=\hat{σ}ₐ²+\hat{σ}ₜ₁²+\hat{σ}ₛ², thus

$${h}^{2} = {H}^{2} = \frac{{\hat{V}}_{A}}{{\hat{V}}_{P}} .$$

Model 2 (AD_ped) and 8 (Gad_MM) included additive and dominance effects. Thus, the estimated additive variance (V⁻_{↓}A) plus dominance variance estimation (V⁻_{↓}D) equals the genetic variance component (V⁻_{↓}G) as epistasis effect was assumed to be zero \hat{V}_{G}=\hat{V}_{A}+\hat{V}_{D}=\hat{σ}ₐ²+\hat{σ}_{d}² and the total variance is \hat{V}ₚ=\hat{σ}ₐ²+\hat{σ}ₜ₁²+\hat{σ}_{d}²+\hat{σ}ₜ₂²+\hat{σ}ₛ², thus

$${h}^{2} = \frac{{\hat{V}}_{A}}{{\hat{V}}_{P}} , {d}^{2} = \frac{{\hat{V}}_{D}}{{\hat{V}}_{P}} and {H}^{2} = \frac{{\hat{V}}_{A} + {\hat{V}}_{D}}{{\hat{V}}_{P}} .$$

Model 3 (ADAA_ped) and 8 (Gadaa_MM) expanded model 2 to include epistasis as Add×Add interaction. Here the genetic variance component (V⁻_{↓}G) is \hat{V}_{G}=\hat{V}_{A}+\hat{V}_{D}+\hat{V}_{AA}=\hat{σ}ₐ²+\hat{σ}_{d}²+\hat{σ}ᵢₐₐ² and the total variance is \hat{V}ₚ=\hat{σ}ₐ²+\hat{σ}ₜ₁²+\hat{σ}_{d}²+\hat{σ}ₜ₂²+\hat{σ}ᵢₐₐ²+\hat{σ}ₛ², then

$${h}^{2} = \frac{{\hat{V}}_{A}}{{\hat{V}}_{P}} , {d}^{2} = \frac{{\hat{V}}_{D}}{{\hat{V}}_{P}} , {i}^{2} = \frac{{\hat{V}}_{AA}}{{\hat{V}}_{P}} and {H}^{2} = \frac{{\hat{V}}_{A} + {\hat{V}}_{D} + {\hat{V}}_{AA}}{{\hat{V}}_{P}} .$$

Models 4 (ADDD_ped) and 9 (Gaddd_MM) were similar to model 3 but replaced the epistasis effect by Dom×Dom interaction, while model 5 (ADAD_ped) and model 10 (Gadad_MM) were similar to model 4 but replaced the epistasis effect by Add×Dom interaction. Finally, model 6 (FULL_ped) and model 11 (Full_MM) included all effects mentioned above. In this model the genetic variance component (V⁻_{↓}G) is \hat{V}_{G}=\hat{V}_{A}+\hat{V}_{D}+\hat{V}_{AA}+\hat{V}_{DD}+\hat{V}_{AD}=\hat{σ}ₛ²+\hat{σ}_{d}²+\hat{σ}ᵢₐₐ²+\hat{σ}_{idd}²+\hat{σ}_{iad}² and the total variance is \hat{V}ₚ=\hat{σ}ₐ²+\hat{σ}ₜ₁²+\hat{σ}_{d}²+\hat{σ}ₜ₂²+\hat{σ}ᵢₐₐ²+\hat{σ}_{idd}²+\hat{σ}_{iad}²+\hat{σ}ₛ², then

$${h}^{2} = \frac{{\hat{V}}_{A}}{{\hat{V}}_{P}} , {d}^{2} = \frac{{\hat{V}}_{D}}{{\hat{V}}_{P}} , {i}^{2} = \frac{{\hat{V}}_{AA} + {\hat{V}}_{DD} + {\hat{V}}_{AD}}{{\hat{V}}_{P}} and$$

$${H}^{2} = \frac{{\hat{V}}_{A} + {\hat{V}}_{D} + {\hat{V}}_{AA} + {\hat{V}}_{DD} + {\hat{V}}_{AD}}{{\hat{V}}_{P}} .$$

### Example 4

### Testing and Validation of Models

The Akaike Information Criteria (AIC) was calculated for all models (Akaike 1974) and can be used to compare model fitting. The capacity of the different parameterizations to partition the variances estimated by the different models was evaluated using the sampling correlation matrix (R) among variance components estimates (Lee et al., Genet Select Evol, 42, 2010). The variance covariance matrix of estimated variance components (V) was used to estimate R as R=L^{-i/2}VL^{-i/2}, where L is the diagonal of the V matrix.

The prediction ability of the different models was tested with a 10-fold cross validation with a random sub-sampling partitioning fixed for all models (Kohavi, Machine Learning: Ecml-95, 174-189, 1995). Briefly, the genotypes were partitioned in 10 groups. And models were run 10-times with different 9 groups every time, while the 10th group was used to validate the models. At the end, all genotypes had their BV predicted from the model (PBV). On the other hand the BV derived from the models using the complete dataset was assumed to be the real BV (RBV). The predictive ability of each model was tested as the correlation between RBV and PBV, and between predicted (PR) and real rankings (RR) for the top 10% genotypes, emulating an operational selection scenario.

### Example 5

### Results

The variance components, genetic parameters and indicators of data fitting, estimated with each of the twelve alternative models are shown in Table 1. The Ga_MM model had an increase in the heritability when compared to the A_ped model. In both cases, similar high (>0.40) narrow-sense heritability (h²) was observed, which at the same time represent the total genetic variance, as non-additive effects were assumed to be zero in these two models. When the dominance effect was included in the pedigree-based model (AD_ped) a decrease of approximately 26% in the narrow-sense heritability (h²) was observed. In addition, the dominance ratio (d²) was estimated to 0.07, which represents 23% of the additive but non-significant (2*SE(d²)>0.08). When the dominance effect was included in the molecular markers-based model (Gad_MM) the h² decrease considerably (47%) to 0.24 and d² was estimated in 0.16, a highly significant 70% of the additive value. Under this model the dominance variance represents a 40% of the total genetic variation. These models were further extended to include the Add×Add, Dom×Dom and Add×Dom two-way epistatic interaction factor in three separate models. In the case of the pedigree-based models these are ADAA_ped, ADDD_ped and ADAD_ped, respectively. In the pedigree models including epistasis the estimations of variance components for additive and dominance varied slightly (non-significant difference) with respect to the AD_ped model. Also, in the three cases the estimation of epistasis was null. However, when the Add×Add interaction was added in the marker-based model (Gadaa_MM) the additive and dominance ratios (h² and d²) dropped considerably, while the Add×Add interaction reached a level of 0.23. This last model could not fit as originally planned and an alternative without the culture-by-epistasis interaction was fitted. When the Dom×Dom and Add×Dom interaction were added in the model (Gaddd_MM and Gadad_MM) the additive component dropped more than 30% and the dominance 88%, with respect to the Gad_MM model, while the epistasis ratio (i²) was estimated on 0.15 and 0.17 for the Gadd_MM and Gadad_MM, respectively. Finally, a full model including additive, dominance and all two-way epistatic interactions were fitted for pedigree (Full_ped) and marker-based (Full_MM). In the case of the pedigree, the full model did not converge and a reduced version including additive, dominance, Add×Add and Dom×Dom was fitted. In this model the additive component decrease slightly to 0.27, the dominance was estimated on zero and the epistasis (as the sum of Add×Add and Dom×Dom) was estimated on 0.10. The estimation of variance components with the full marker-based model (Full_MM) was similar to the Gadad_MM model. Under this model the epistatic interaction was calculated as the sum of Add×Add, Dom×Dom and Add×Dom, being the second the one with the highest contribution while the last was almost zero.

Including the non-additive effects improves the fitting of the data. Although this improvement is small for pedigree models there is a large improvement on the marker-based models (Table 1). However, out of models including non-additive effects the variance components are different. Consequently, the sampling correlation among the variance component estimation was studied to evaluate which of the 10 models was able to better partition the variance (Table 3). The correlation between additive/dominance with epistasis cannot be estimated under the pedigree models as the estimation of the epistasis variance was zero (Table 3). The distribution of the eigenvalues of the portion of the correlation matrices with genetic significance (additive, dominance, epistasis and error) was calculated (FIG. 1) excluding additive-only models. As reference, the distribution of eigenvalues for a perfect orthogonal correlation matrix (identity) is shown (FIG. 1a) with all equal to 1, representing the ideal model. The distribution of the eigenvalues is narrowed for the matrix of correlation from model Gad_MM outperforming the one from model AD_ped (FIG. 1b), as an example, the correlation between additive and dominance decrease from 0.90 with the AD_ped to 0.70 with the Gad_MM model (Table 3). In general, all the marker-based models including epistasis outperform their pedigree-based counterpart. Models Gadd_MM and Gadad_MM showed the best performance (FIG. 1c), with correlation values between additive and dominance/epistasis below 0.4 (Table 3). These eigenvalue distributions are only comparable for matrices of the same dimension. Thus, the distributions cannot be used to compare between sections b with c in FIG. 1.

Given the results above, the standard error of the prediction (SEP) for models including Dom×Dom and Add×Dom for pedigree- and marker-based models was studied. The SEP pattern found for the BV and DV for each of the 860 individuals are presented in FIG. 3. The BV's SEP for marker-based models were smaller than the pedigree based in 99.8% of the cases (FIG. 2a, c). In the case of the DV there is a clear advantage on the marker-based models over the pedigree-based with almost all SEP more than 40% worse in the pedigree based (FIG. 2b, d).

If a given model can estimate variance components free of noise (low correlation among effects) the prediction of BV using these estimations should be more accurate. Following this assumption, testing was performed using cross-validation of the additive models and models including Dom×Dom and Add×Dom for both pedigree- and marker-based matrices (Table 2). The BV was predicted with a 10-fold cross validation, and it was found that when replacing the A matrix (model A_ped) by the Ga matrix (model Ga-MM) in the additive models the prediction ability increases slightly by 4%. However, the inclusion of the non-additive effects (D and either Add×Dom or Dom×Dom) significantly increases the prediction ability by 13% and 14% in the pedigree-based models, respectively. The marker-based models increase by 30% in both cases when compared with the Ga_MM, and by 36% when compared to A_ped. The Mean Square Error (MSE) showed almost a 50% significant decrease from the additive models (A_ped) to the more complex pedigree-based models. The MSE further decreased in the marker-based models (Gadad_MM and Gaddd_MM) to 10-12% of the MSE in the additive models. Furthermore, the ranking correlation out of the 10-fold cross validation was calculated. The correlation of ranking position including all genotypes showed similar values as the correlation between BVs showed above. However, in a breeding program scenario, it is not only important to predict the trend and magnitude of the complete set of genotypes, but it is also important to predict the potential selection of (top) individuals. Here, a selection of the top 10% was emulated, and the correlation of the true ranking position given by the model including all data was studied, and the predicted position in the ranking using the model in a cross-validation scenario (Table 2). The capacity to predict the top 10% doubled when the A matrix was replaced by the Ga matrix in the additive models (A_ped and Ga_MM) and further increased for the Gadad_MM model to 0.37, doubling the correlations observed in the non-additive pedigree-based models. The correlation for the model Gaddd_MM was a little lower than the model Ga_MM, however still yielded an 80% increase over the best pedigree model.

TABLE 1
Variance estimation, genetic parameters (standard errors in parenthesis), and measure of data fitting.

| | A_ped | Ga_MM | AD_ped | Gad_MM | ADAA_ped | ADDD_ped | Gaddd_MM | ADAD_ped | Gadad_MM |
|---|---|---|---|---|---|---|---|---|---|
| Incomplete block (Iblk) | 2512.10 | 2491.64 | 2513.88 | 2491.69 | 2514.21 | 2513.72 | 2504.49 | 2514.05 | 2503.37 |
| Additive (Add) | 3682.82 | 4367.48 | 2599.18 | 2130.05 | 2577.58 | 2516.89 | 1327.21 | 2553.12 | 1105.90 |
| Dominance (Dom) | — | — | 622.84 | 1452.33 | 606.84 | 636.18 | 195.77 | 623.13 | 204.43 |
| Epistasis Add × Add | — | — | — | — | 0.01 | — | — | — | — |
| Epistasis Dom × Dom | — | — | — | — | — | 0.00 | 1231.60 | — | — |
| Epistasis Add × Dom | — | — | — | — | — | — | — | 0.00 | 1432.87 |
| Culture × Add | 200.95 | 138.18 | 115.88 | 146.63 | 0.00 | 92.04 | 80.29 | 91.83 | 59.06 |
| Culture × Dom | — | — | 127.51 | 4.76 | 0.00 | 0.00 | 0.00 | 0.00 | 0.00 |
| Culture × (Add × Add) | — | — | — | — | 282.85 | — | — | — | — |
| Culture × (Dom × Dom) | — | — | — | — | — | 213.40 | 189.52 | — | — |
| Culture × (Add × Dom) | — | — | — | — | — | — | — | 196.84 | 214.24 |
| Residual | 5129.61 | 5263.04 | 5095.98 | 5198.93 | 5068.76 | 5054.42 | 5073.86 | 5065.71 | 5075.45 |
| Total Variance | 9013.38 | 9768.70 | 8561.38 | 8932.70 | 8536.04 | 8512.93 | 8098.25 | 8530.64 | 8091.95 |
| h² | 0.409 | 0.447 | 0.304 | 0.239 | 0.302 | 0.296 | 0.164 | 0.299 | 0.137 |
| SE (h²) | (0.018) | (0.021) | (0.059) | (0.039) | (0.058) | (0.058) | (0.041) | (0.058) | (0.043) |
| d² | na | na | 0.073 | 0.163 | 0.071 | 0.075 | 0.024 | 0.073 | 0.025 |
| SE (d²) | | | (0.044) | (0.032) | (0.043) | (0.042) | (0.039) | (0.043) | (0.040) |
| i² | na | na | na | na | 0.000 | 0.000 | 0.152 | 0.000 | 0.177 |
| SE (i²) | | | | | (0.000) | (0.000) | (0.034) | (0.000) | (0.039) |
| H² | 0.409 | 0.447 | 0.376 | 0.401 | 0.373 | 0.370 | 0.340 | 0.372 | 0.339 |
| SE (H²) | (0.018) | (0.021) | (0.023) | (0.020) | (0.023) | (0.023) | (0.021) | (0.024) | (0.021) |
| LogLikelihood | −1299.40 | −1336.44 | −1295.37 | −1311.63 | −1294.83 | −1293.90 | −1294.95 | −1294.38 | −1294.77 |
| AIC | 2606.80 | 2680.88 | 2602.74 | 2635.26 | 2605.66 | 2603.80 | 2605.90 | 2604.76 | 2605.54 |

TABLE 2
Predictive ability, Mean Square Error (MSE), and top 10% ranking
correlation (Top10% RankCor) for selected models.

| Model | Cor(RBV, PBV) | MSE(RBV, PBV) | Top10% RankCor |
|---|---|---|---|
| A_ped | 0.640 | 1335.800 | 0.17 |
| Ga_MM | 0.670 | 1291.800 | 0.34 |
| ADAD_ped | 0.727 | 657.258 | 0.16 |
| Gadad_MM | 0.872 | 108.240 | 0.37 |
| ADDD_ped | 0.732 | 638.464 | 0.18 |
| Gaddd_MM | 0.873 | 151.199 | 0.32 |

TABLE 3
Sampling correlation matrix for all models tested. Above diagonal pedigree-based and below diagonal marker-based
models. (A) additive models, (B) additive plus dominance models, (C) additive plus dominance plus additive by additive
(Add × Add) interaction, (D) additive plus dominance plus dominance by dominance (Dom × Dom) interaction,
(E) additive plus dominance plus additive by dominance (Add × Dom) interaction, and (F) full models. I. block,
incomplete block; Add, Additive component; Dom, dominance component; Cult, silviculture type.

| A | I. Block | Add | Cult × Add | Residual |
|---|---|---|---|---|
| I. Block | 1.00 | 0.00 | 0.01 | −0.07 |
| Add | 0.00 | 1.00 | −0.14 | −0.08 |
| Cult × Add | 0.01 | −0.08 | 1.00 | −0.24 |
| Residual | −0.07 | −0.13 | −0.19 | 1.00 |

| B | I. Block | Add | Dom | Cult × Add | Cult × Dom | Residual |
|---|---|---|---|---|---|---|
| I. Block | 1.00 | 0.00 | 0.00 | 0.00 | 0.01 | −0.07 |
| Add | 0.00 | 1.00 | −0.90 | −0.08 | 0.05 | −0.04 |
| Dom | 0.00 | −0.70 | 1.00 | 0.09 | −0.15 | 0.02 |
| Cult × Add | 0.00 | −0.12 | 0.12 | 1.00 | −0.62 | 0.02 |
| Cult × Dom | 0.01 | 0.09 | −0.17 | −0.69 | 1.00 | −0.26 |
| Residual | −0.07 | −0.05 | −0.02 | 0.00 | −0.19 | 1.00 |

| C | I. Block | Add | Dom | Add × Add | Cult × Add | Cult × Dom | Cult × (Add × Add) | Residual |
|---|---|---|---|---|---|---|---|---|
| I. Block | 1.00 | 0.00 | 0.00 | −0.07 | −0.07 | −0.07 | 0.01 | −0.07 |
| Add | 0.00 | 1.00 | −0.89 | −0.02 | −0.02 | −0.02 | −0.04 | −0.02 |
| Dom | −0.01 | −0.19 | 1.00 | 0.01 | 0.01 | 0.01 | −0.07 | 0.01 |
| Add × Add | 0.00 | −0.55 | −0.56 | 1.00 | 1.00 | 1.00 | −0.30 | 1.00 |
| Cult × Add | 0.00 | −0.11 | 0.11 | 0.00 | 1.00 | 1.00 | −0.30 | 1.00 |
| Cult × Dom | 0.01 | 0.07 | −0.16 | 0.01 | −0.69 | 1.00 | −0.30 | 1.00 |
| Cult × (Add × Add) | — | — | — | — | — | — | 1.00 | −0.30 |
| Residual | −0.07 | 0.03 | 0.03 | −0.07 | −0.01 | −0.19 | — | 1.00 |
| D | I. Block | Add | Dom | Dom × Dom | Cult × Add | Cult × Dom | Cult × (Dom × Dom) | Residual |
| I. Block | 1.00 | 0.00 | 0.00 | −0.07 | 0.01 | −0.07 | 0.00 | −0.07 |
| Add | 0.00 | 1.00 | −0.89 | −0.01 | −0.02 | −0.01 | −0.05 | −0.01 |
| Dom | 0.00 | −0.35 | 1.00 | 0.01 | 0.04 | 0.01 | −0.07 | 0.01 |
| Dom × Dom | 0.00 | −0.29 | −0.62 | 1.00 | 0.02 | 1.00 | −0.31 | 1.00 |
| Cult × Add | 0.00 | −0.09 | 0.00 | 0.10 | 1.00 | 0.02 | −0.48 | 0.02 |
| Cult × Dom | −0.07 | 0.00 | 0.01 | −0.02 | 0.04 | 1.00 | −0.31 | 1.00 |
| Cult × | 0.01 | 0.04 | 0.00 | −0.18 | −0.52 | −0.31 | 1.00 | −0.31 |
| (Dom × Dom) | | | | | | | | |
| Residual | −0.07 | 0.00 | 0.01 | −0.02 | 0.04 | 1.00 | −0.31 | 1.00 |
| E | I. Block | Add | Dom | Add × Dom | Cult × Add | Cult × Dom | Cult × (Add × Dom) | Residual |
| I. Block | 1.00 | 0.00 | 0.00 | −0.07 | 0.01 | −0.07 | 0.00 | −0.07 |
| Add | 0.00 | 1.00 | −0.89 | −0.02 | −0.03 | −0.02 | −0.02 | −0.02 |
| Dom | 0.00 | −0.29 | 1.00 | 0.01 | 0.06 | 0.01 | −0.10 | 0.01 |
| Add × Dom | 0.00 | −0.38 | −0.62 | 1.00 | 0.03 | 1.00 | −0.30 | 1.00 |
| Cult × Add | 0.00 | −0.10 | 0.00 | 0.11 | 1.00 | 0.03 | −0.54 | 0.03 |
| Cult × Dom | −0.07 | 0.00 | 0.01 | −0.02 | 0.08 | 1.00 | −0.30 | 1.00 |
| Cult × (Add × Dom) | 0.01 | 0.05 | 0.00 | −0.17 | −0.62 | −0.31 | 1.00 | −0.30 |
| Residual | −0.07 | 0.00 | 0.01 | −0.02 | 0.08 | 1.00 | −0.31 | 1.00 |

| F | I. Block | Add | Dom | Add × Add | Dom × Dom | Add × Dom | Cult × Add | Cult × Dom | Residual |
|---|---|---|---|---|---|---|---|---|---|
| I. Block | 1.00 | 0.00 | −0.07 | 0.00 | −0.07 | — | 0.00 | 0.01 | −0.07 |
| Add | 0.00 | 1.00 | −0.03 | −0.94 | −0.03 | — | −0.09 | 0.10 | −0.03 |
| Dom | −0.01 | −0.29 | 1.00 | 0.02 | 1.00 | — | 0.02 | −0.26 | 1.00 |
| Add × Add | 0.00 | −0.68 | 0.02 | 1.00 | 0.02 | — | 0.11 | −0.17 | 0.02 |
| Dom × Dom | 0.00 | 0.52 | −0.30 | −0.90 | 1.00 | — | 0.02 | −0.26 | 1.00 |
| Add × Dom | −0.07 | 0.00 | 0.04 | 0.01 | −0.04 | 1.00 | — | — | — |
| Cult × Add | 0.00 | −0.10 | 0.11 | 0.00 | 0.00 | −0.01 | 1.00 | −0.62 | 0.02 |
| Cult × Dom | 0.01 | 0.07 | −0.16 | 0.00 | 0.01 | −0.19 | −0.69 | 1.00 | −0.26 |
| Residual | −0.07 | 0.00 | 0.04 | 0.01 | −0.04 | 1.00 | −0.01 | −0.19 | 1.00 |

### Example 6

### Mate-Pair Allocation

The prediction of the genotype effects of future matings given the estimates of additive (a) and dominance (d) effects can be calculated by:

$${G}_{ij} = {\sum }_{k = 1}^{N} [ {P ( AA )}_{ijk} {a}_{k} + {P ( Aa )}_{ijk} {d}_{k} - {P ( aa )}_{ijk} {a}_{k} ]$$

where Gᵢⱼ is the mean predicted performance of the offspring originated from the cross between individual i and individual j. P(AA)ᵢⱼₖ, P(Aa)ᵢⱼₖ, P(aa)ᵢⱼₖ are the probabilities that k-th marker of the predicted progeny has genotype AA, Aa and aa, respectively.

Based on the advanced prediction model developed for the trait height, for the CCLONES population described above, the mean value was estimated in silico for each family that could potentially be created by crossing any two individuals in CCLONES. FIG. 3 shows the predicted height mean family value, for all possible crosses between any two individuals of CCLONES, derived using the prediction model with dominance. For CCLONES, a total of 428,275 crosses ((926×925)÷2) are possible between any two of the 926 individuals of the population (excluding reciprocal crosses). Thus, the mean family value was predicted in silico of all possible mate pairs using the predictive models that include additive and dominance effects.

### Example 7

### Data Collection and Processing

With regard to FIG. 4, an illustration of an illustrative computing system 400 that may be utilized for generating and maintaining molecular marker-derived matrices is shown. The computing system may include a processing unit 402 that includes one or more computer processors. The processing unit 402 may execute software 404 used in performing functionality in accordance with the principles of the present invention as further described herein. The processing unit 402 may be in communication with a (i) memory 406 configured to store data being generated and utilized by the processing unit 402 and software for execution by the processing unit 402, (ii) I/O unit 408 that may be configured to communicate externally from the computing system 400, such as over a communications network (e.g., the Internet or via a sensing system), and (iii) storage unit 410 that may be configured to store one or more data repository 412a-412n (collectively 412). The data repositories 412 may be configured to store data utilized in generating and maintaining molecular marker-derived matrices. The data repositories may include raw data as well as processed data. The molecular marker-derived matrices may be stored in a flat-file, such as a table or spreadsheet, or a database, such as a object oriented database, as understood in the art.

In one embodiment, the data being stored by the one or more data repositories 412 may be collected and processed by the software 404 being executed by the processing unit 402. In collecting data for use in generating the molecular marker-derived matrices, the processing unit 402 may be configured to include a data collection system, either automated or manual (e.g., graphical user interface in which a user types collected data).

FIG. 5 is a flow diagram of an illustrative process 500 for breeding an individual or a pair of individuals in accordance with the principles of the present invention. At least a portion of the steps presented in the process 500 may be performed by the computing system of FIG. 4. The process 500 may start at step 502, where a genotype of multiple individuals for multiple genetic markers may be determined, as previously described herein. At step 504, a molecular marker-derived matrix that includes additive and non-additive effects may be constructed. The construction may be performed automatically or semi-automatically by software executed on the computing system. At step 506, an estimated breeding value for each individual may be obtained. Obtaining the estimated breeding value may be calculated using the computing system as previously described. At step 508, an individual with a desired estimated breeding value for breeding may be selected. In selecting the individual, the selection process may be automated, semi-automated, or manually performed based on a variety of factors, as previously described herein. At step 510, the selected individual may be bred to another individual as understood in the art. At step 512, a predicted mean family genetic value for each potential progeny of any two of the individuals genotyped in step 502 may be obtained. The predicted mean family genetic value may be calculated using the computing system as previously described. At step 514, a potential progeny may be selected based on a desired predicted mean family genetic value. In selecting the potential progeny, the selection process may be automated, semi-automated, or manually performed based on a variety of factors, as previously described herein. At step 516, the parents of the selected potential progeny may be determined and at step 518, the parents of the selected potential progeny may be bred to one another as understood in the art.

The previous description is of a preferred embodiment for implementing the invention, and the scope of the invention should not necessarily be limited by this description. The scope of the present invention is instead defined by the following claims.

What is claimed is:

1. A method of obtaining an individual with a desired estimated breeding value, said method comprising:
(a) determining a genotype of a plurality of individuals for a plurality of genetic markers;
(b) constructing a molecular marker-derived matrix comprising additive and non-additive effects;
(c) obtaining an estimated breeding value (EBV) for the individuals based on said matrix comprising additive and non-additive effects; and
(d) selecting at least a first individual with a desired EBV for breeding.

2. The method of claim 1, wherein the non-additive effects comprise dominance effects or epistatic effects.

3. The method of claim 2, wherein the epistatic effects comprise additive-by-additive (Add×Add) interactions, dominance-by-dominance (Dom×Dom) interactions, or additive-by-dominance (Add×Dom) interactions.

4. The method of claim 1, wherein the dominance relationship matrix is constructed using the formula:
$$D = \frac{{WW}^{′}}{{\sum }_{j = 1}^{m} 2 {p}_{j} {q}_{j} ( 1 - 2 {p}_{j} {q}_{j} )} .$$

5. The method of claim 4, wherein Wij=1−2pⱼqⱼ if the individual is heterozygous, Wij=0 if the individual has a missing data, and Wij=0−2pⱼqⱼ if the individual is homozygous.

6. The method of claim 1, wherein said selecting occurs before an individual fully exhibits a trait.

7. The method of claim 1, wherein said genetic markers are polymorphic.

8. The method of claim 1, wherein said genetic markers are selected from the group consisting of unique expressed sequence tags (EST); restriction fragment length polymorphisms (RFLP), amplified fragment length polymorphisms (AFLP), simple sequence repeats (SSR), simple sequence length polymorphisms (SSLPs), single nucleotide polymorphisms (SNP), insertion/deletion polymorphisms (Indels), variable number tandem repeats (VNTR), and random amplified polymorphic DNA (RAPD), and isozymes.

9. The method of claim 1, wherein the minor genotype frequency of the genetic markers is greater than 0.12.

10. The method of claim 1, wherein each genetic marker has a predetermined association with at least one desired trait or phenotype.

11. The method of claim 10, wherein the desired phenotype is monogenic, quantitative, or polygenic.

12. The method of claim 1, further comprising:
(e) breeding said individual to a second individual to obtain progeny.

13. The method of claim 12, wherein said second individual is selected based on an obtained estimated breeding value.

14. The method of claim 12, further comprising
(f) determining a genotype of a plurality of said progeny for a plurality of genetic markers;
(g) constructing a molecular marker-derived matrix comprising additive and non-additive effects;
(h) obtaining an estimated breeding value (EBV) for said progeny based on said matrix comprising additive and non-additive effects;
(i) selecting at least a first progeny from said plurality with a desired EBV for breeding.

15. The method of claim 1, wherein the individual is a plant.

16. The method of claim 15, wherein the plant is a corn, canola, flax, alfalfa, rice, rye, sorghum, sunflower, wheat, soybean, tobacco, potato, peanut, cotton, sweet potato, cassava, coffee, coconut, pineapple, citrus, banana, fig, sugar beet, oat, barley, vegetable, turfgrass, tree or ornamental plant.

17. The method of claim 1, wherein the individual is an animal.

18. The method of claim 17, wherein the animal is a horse, beef cattle, dairy cattle, swine, poultry, sheep, goat, or fish.

19. A method of obtaining a progeny individual with a desired genetic value, said method comprising:
(a) determining a genotype of a plurality of individuals for a plurality of genetic markers;
(b) constructing a molecular marker-derived predicted progeny performance matrix comprising additive and non-additive effects;
(c) obtaining a predicted mean family genetic value for a plurality of potential progeny of any two of said plurality of individuals, wherein said predicted mean family genetic value is based on said predicted progeny performance matrix comprising additive and non-additive effects;
(d) selecting at least a first potential progeny with a desired predicted mean family genetic value;
(e) determining the pair individuals from said plurality of individuals corresponding to the parents of the selected potential progeny; and
(f) breeding said pair of individuals to produce a progeny individual with a desired genetic value.

20. The method of claim 19, wherein the non-additive effects comprise dominance effects or epistatic effects.

21. The method of claim 20, wherein the epistatic effects comprise additive-by-additive (Add×Add) interactions, dominance-by-dominance (Dom×Dom) interactions, or additive-by-dominance (Add×Dom) interactions.

22. The method of claim 19, wherein the predicted progeny performance matrix is constructed using the formula:
Gᵢⱼ=Σₖ₌₁^{N}[P(AA)ᵢⱼₖaₖ+P(Aa)ᵢⱼₖdₖ−P(aa)ᵢⱼₖaₖ].

23. The method of claim 19, wherein said genetic markers are polymorphic.

24. The method of claim 19, wherein said genetic markers are selected from the group consisting of unique expressed sequence tags (EST); restriction fragment length polymorphisms (RFLP), amplified fragment length polymorphisms (AFLP), simple sequence repeats (SSR), simple sequence length polymorphisms (SSLPs), single nucleotide polymorphisms (SNP), insertion/deletion polymorphisms (Indels), variable number tandem repeats (VNTR), and random amplified polymorphic DNA (RAPD), and isozymes.

25. The method of claim 19, wherein the minor genotype frequency of the genetic markers is greater than 0.12.

26. The method of claim 19, wherein each genetic marker has a predetermined association with at least one desired trait or phenotype.

27. The method of claim 26, wherein the desired phenotype is monogenic, quantitative, or polygenic.

28. The method of claim 19, wherein the progeny individual is a plant.

29. The method of claim 28, wherein the plant is a corn, canola, flax, alfalfa, rice, rye, sorghum, sunflower, wheat, soybean, tobacco, potato, peanut, cotton, sweet potato, cassava, coffee, coconut, pineapple, citrus, banana, fig, sugar beet, oat, barley, vegetable, turfgrass, tree or ornamental plant.

30. The method of claim 19, wherein the progeny individual is an animal.

31. The method of claim 30, wherein the animal is a horse, beef cattle, dairy cattle, swine, poultry, sheep, goat, or fish.
